(19) United States
(12) Patent Application Publication
(10) Pub. No.: US 2026/0254133 A1
(43) Pub. Date: Aug. 27, 2026

(54) DUAL-FREQUENCY SHARED-APERTURE RADIATION UNIT AND ANTENNA

(71) Applicant: CICT MOBILE COMMUNICATION TECHNOLOGY CO., LTD., Wuhan (CN)

(72) Inventors: Qiang ZHANG, Wuhan (CN); Zhenggui LIU, Wuhan (CN); Lijun PAN, Wuhan (CN); Chenfei LV, Wuhan (CN)

(21) Appl. No.: 18/870,643

(22) PCT Filed: Oct. 18, 2023
(86) PCT No.: PCT/CN2023/125202

§ 371 Date: Nov. 30, 2024

(30) Foreign Application Priority Data
Oct. 24, 2022 (CN) 202211305658.4

(51) Int. Cl. H01Q 21/26; H01Q 1/24; H01Q 5/42; H01Q 5/48; H01Q 21/06

(52) U.S. Cl. CPC H01Q 21/26; H01Q 1/246; H01Q 5/42; H01Q 5/48; H01Q 21/062

(57) ABSTRACT

The present application relates to the technical field of communication antennas, and provides a dual-frequency shared-aperture radiation unit and an antenna. The dual-frequency shared-aperture radiation unit comprises a feed base, a first frequency band radiator, a first frequency band feed group, a second frequency band radiator, and a second frequency band feed group. The feed base comprises a metal base and feed baluns, and the feed baluns are embedded in the metal base. The first frequency band radiator and the second frequency band radiator are both arranged on the metal base, and the second frequency band radiator is nested in the first frequency band radiator. The first frequency band feed group comprises a plurality of first feed members. One end of each first feed member is connected to the first frequency band radiator, and the other end of the first feed member is connected to the feed balun in a combined manner, so as to feed the first frequency band radiator. The second frequency band feed group feeds the second frequency band radiator.

### CROSS-REFERENCES TO RELATED APPLICATIONS

The present application is a National Stage of International Application No. PCT/CN2023/125202, filed on Oct. 18, 2023, which claims priority to Chinese patent application No. 202211305658.4 filed on Oct. 24, 2022, entitled “Dual-Frequency Shared-Aperture Radiation Unit and Antenna”, which are hereby incorporated by reference in their entireties.

### FIELD

The present application relates to the field of communication antenna, and in particular, to a dual-frequency shared-aperture radiation unit and an antenna.

### BACKGROUND

With the development of 5G communication technologies, 4G/5G fusion antennas have become mainstream antennas. However, multi-frequency fusion requires more for antennas, such as achieving miniaturization of antenna size as well as fusion of multiple frequency bands and multiple standards, and ensuring that each frequency band indicator does not deteriorate; meanwhile, costs and weight are also important assessment indicators for antennas, making miniaturization, high performance, and low costs the goals of designers in antenna development.

The traditional high-low frequency shared-aperture radiation unit adopts a scheme of radiation unit line plus terminal, having poor intermodulation stability, low reliability, and requiring electroplating for the radiator of the radiation unit, resulting in high production costs.

### BRIEF SUMMARY

The present application provides a dual-frequency shared-aperture radiation unit and an antenna to address the problems of low reliability and high costs of multi-frequency and multi-system antennas in the related art.

In one embodiment of the present application provides a dual-frequency shared-aperture radiation unit, including:
a feed base, including a metal base and a feed balun, where the feed balun is embedded in the metal base and the feed balun is connected to an external unit;
a first-frequency-band radiator, disposed at the metal base, where the first-frequency-band radiator includes at least one polarization composed of a symmetrical dipole binary array;
a first-frequency-band feed group, including multiple first feed members, where an end of one first feed member is connected to one first-frequency-band dipole, and ends of two first feed members of the same polarization not connected to the first-frequency-band dipole are combined to the feed balun to feed the first-frequency-band radiator;
a second-frequency-band radiator, embedded in the first-frequency-band radiator and disposed at the metal base, where the second-frequency-band radiator includes at least one polarization composed of a symmetrical dipole binary array; and
a second-frequency-band feed group, including at least one second feed member, where one second feed member is disposed corresponding to a second-frequency-band binary array of one polarization to feed the second-frequency-band radiator.

In an embodiment, according to the dual-frequency shared-aperture radiation unit provided by the present application, the metal base is provided with a first through-hole; the feed balun includes an inner core and a plastic medium, where the plastic medium is wrapped around an outside of the inner core, and the inner core and the plastic medium are embedded in the first through-hole; a first end of the inner core is connected to the first feed member, and a second end of the inner core is connected to the external unit.

In an embodiment, according to the dual-frequency shared-aperture radiation unit provided by the present application, the metal base is further provided with a second through-hole; the second feed member includes a connecting section and a feed section, where the connecting section is passed through the second through-hole and connected to the external unit, and the feed section is connected to a corresponding second-frequency-band binary array.

In an embodiment, according to the dual-frequency shared-aperture radiation unit provided by the present application, a bottom of the metal base is provided with a first metal support and a second metal support, the first through-hole penetrates through the first metal support, and the second through-hole penetrates through the second metal support; a bottom of the first-frequency-band radiator is provided with a first metal via-hole and a second metal via-hole, where the first metal via-hole is disposed corresponding to the first through-hole, and the second metal via-hole is disposed corresponding to the second through-hole.

In an embodiment, according to the dual-frequency shared-aperture radiation unit provided by the present application, the first-frequency-band radiator, the second-frequency-band radiator, and the feed base are separately disposed.

In an embodiment, according to the dual-frequency shared-aperture radiation unit provided by the present application, the first-frequency-band radiator is connected to the second-frequency-band radiator and the feed base, or the first-frequency-band radiator is rigidly connected to the second-frequency-band radiator and the feed base through a metal fastener.

In an embodiment, according to the dual-frequency shared-aperture radiation unit provided by the present application, a bottom of the first-frequency-band radiator is provided with a first connecting hole and a second connecting hole, where the first connecting hole is fixedly connected to the metal base through a fastener, and the second connecting hole is fixedly connected to the second-frequency-band radiator through a fastener.

In an embodiment, according to the dual-frequency shared-aperture radiation unit provided by the present application, the first feed member is a coaxial cable, where an inner conductor of the coaxial cable is connected to the feed balun, and an outer conductor of the coaxial cable is connected to the metal base.

In an embodiment, according to the dual-frequency shared-aperture radiation unit provided by the present application, the second feed member is one of a sheet metal member, a die-casting member, or a printed circuit member.

In an embodiment, according to the dual-frequency shared-aperture radiation unit provided by the present application, the dual-frequency shared-aperture radiation unit further includes a director with sheet-like structure, where the director with sheet-like structure is disposed at a side of the second-frequency-band radiator facing away from the feed base, and the director with sheet-like structure and the second-frequency-band radiator are disposed at intervals.

In one embodiment of the present application further provides an antenna, including any of the dual-frequency shared-aperture radiation units described above.

In an embodiment, the antenna includes multiple dual-frequency shared-aperture radiation units, and the multiple dual-frequency shared-aperture radiation units are a combination of same frequency units or at least partially different frequency units.

In the dual-frequency shared-aperture radiation unit and the antenna provided in the present application, the first-frequency-band radiator and the second-frequency-band radiator are embedded and share a feed base, which results in a compact structure of the dual-frequency shared-aperture radiation unit, achieves the miniaturization of the radiation unit and further reduces the windward area of the antenna; the signal is input to the first-frequency-band radiator through the feed balun, and the signal is input to the second-frequency-band radiator through the second-frequency-band feed group. On the basis of traditional radiation units, terminals and radiation unit lines are removed, which may reduce the number of holes on a reflector plate, improve intermodulation stability, reduce hidden danger in intermodulation caused by welding operations, improve reliability, and achieve low costs; the second-frequency-band radiator is separated from the feed base, and the second-frequency-band radiator does not require electroplating, which may save electroplating costs and further reduce costs. Then, on the basis of antenna miniaturization, the fusion of multiple frequency bands and multiple standards may be achieved, and the indicators of each frequency band do not deteriorate, solving the shortcomings of low reliability and high costs of multi-frequency and multi-system antennas in the related art.

### BRIEF DESCRIPTION OF THE DRAWINGS

To illustrate the embodiments the present application more clearly, the drawings used in the description of the embodiments of the present application are briefly described below. It should be noted that the drawings in the following description are only some embodiments of the present application.

FIG. 1 is a schematic three-dimensional structural diagram of a dual-frequency shared-aperture radiation unit according to an embodiment of the present application;

FIG. 2 is a schematic decomposed structural diagram of a dual-frequency shared-aperture radiation unit according to an embodiment of the present application;

FIG. 3 is a schematic structural diagram of an assembly of a first-frequency-band radiator, a first-frequency-band feed group, a feed base, and a plastic member according to an embodiment of the present application;

FIG. 4 is a schematic structural diagram of an assembly of a first-frequency-band radiator and a first-frequency-band feed group according to an embodiment of the present application;

FIG. 5 is a schematic structural diagram of a second-frequency-band radiator, a second-frequency-band feed group, and a director with sheet-like structure according to an embodiment of the present application;

FIG. 6 is a schematic structural diagram of a second-frequency-band feed group according to an embodiment of the present application;

FIG. 7 is a schematic three-dimensional structural diagram of an assembly of a feed base and a first-frequency-band feed group according to an embodiment of the present application;

FIG. 8 is a schematic decomposed structural diagram of an assembly of a feed base and a first-frequency-band feed group according to an embodiment of the present application;

FIG. 9 is a schematic structural diagram of an assembly of a feed base and a second-frequency-band feed group according to an embodiment of the present application;

FIG. 10 is a schematic structural diagram of a plastic member according to an embodiment of the present application;

FIG. 11 is a radiation parameter diagram of a first-frequency-band radiation of a dual-frequency shared-aperture radiation unit on a horizontal plane according to an embodiment of the present application;

FIG. 12 is a radiation parameter diagram of a second-frequency-band radiation of a dual-frequency shared-aperture radiation unit on a horizontal plane according to an embodiment of the present application;

FIG. 13 is a standing-wave ratio curve of a first-frequency-band radiation of a dual-frequency shared-aperture radiation unit according to an embodiment of the present application; and

FIG. 14 is a standing-wave ratio curve of a second-frequency-band radiation of a dual-frequency shared-aperture radiation unit according to an embodiment of the present application.

Reference signs:
1: feed base; 11: metal base; 111: first through-hole; 112: second through-hole; 113: first metal support; 114: second metal support; 115: welding notch; 12: feed balun; 121: inner core; 122: plastic medium;
2: first-frequency-band radiator; 21: first-frequency-band dipole; 22: first connecting hole; 23: second connecting hole; 24: first metal via-hole; 25: second metal via-hole;
3: first-frequency-band feed group; 31: first feed member;
4: second-frequency-band radiator;
5: second-frequency-band feed group; 51: second feed member; 511: connecting section; 512: feed section; 52: isolating member;
6: director with sheet-like structure; 7: plastic member; 200: external unit.

### DETAILED DESCRIPTION

To make the embodiments of the present application clearer, the embodiments the present application are clearly and completely described in the following with reference to the accompanying drawings in the present application. These embodiments are only a part of the embodiments of the present application, and not all of the embodiments.

It should be noted that the terms “vertical direction”, “horizontal direction”, “+45° or −45° direction”, “up”, “middle”, “down” and similar expressions are for illustrative purposes only, and do not indicate or imply that the apparatus or element referred to must have a specific orientation, be constructed and operated in a specific orientation, and thus cannot be understood as limiting the present application. In addition, the terms “first”, “second”, and “third” are only used for descriptive purposes and cannot be understood as indicating or implying relative importance.

In the present application, unless otherwise specified and limited, the terms “installation”, “connection”, “connected”, “fixation”, etc. should be broadly understood, for example, they may be fixed connections, detachable connections, or integrated; it may be a mechanical connection, an electrical connection, or they may communicate with each other; it may be directly connected or indirectly connected through an intermediate medium, and may be a communication inside two elements or an interaction relationship between two elements, unless otherwise specified. The specific meanings of the above terms in the present application may be understood according to the specific situation.

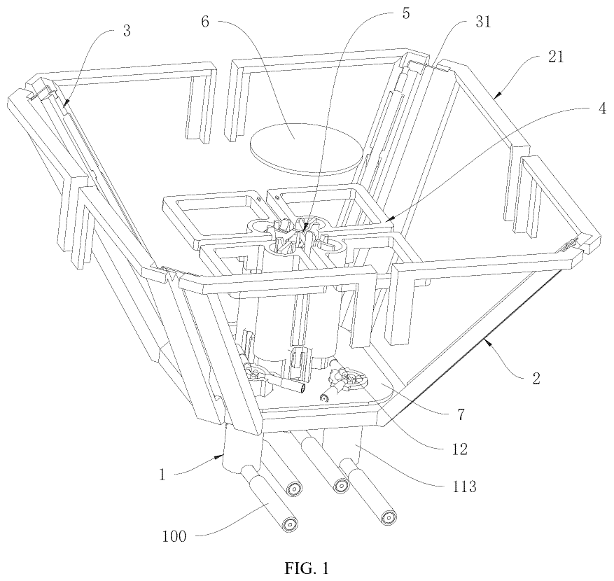

A dual-frequency shared-aperture radiation unit of the present application is described below in conjunction with FIG. 1 to FIG. 10.

As shown in FIG. 1 to FIG. 9, the dual-frequency shared-aperture radiation unit provided in the present application includes a feed base 1, a first-frequency-band radiator 2, a first-frequency-band feed group 3, a second-frequency-band radiator 4, and a second-frequency-band feed group 5. The feed base 1 includes a metal base 11 and a feed balun 12. The feed balun 12 is embedded in the metal base 11 and connected to an external unit 200 to access an external signal. The first-frequency-band radiator 2 is disposed at the metal base 11, and the first-frequency-band radiator 2 includes at least one polarization composed of a symmetrical dipole binary array; the first-frequency-band feed group 3 includes multiple first feed members 31, an end of one first feed member 31 is connected to one first-frequency-band dipole 21, and ends of two first feed members 31 of the same polarization not connected to the first-frequency-band dipole 21 are combined to the feed balun 12 to feed the first-frequency-band radiator 2. The second-frequency-band radiator 4 is embedded in the first-frequency-band radiator 2 and disposed at the metal base 11, where the second-frequency-band radiator 4 includes at least one polarization composed of the symmetrical dipole binary array; the second-frequency-band feed group 5 includes at least one second feed member 51, and one second feed member 51 is disposed corresponding to a second-frequency-band binary array of one polarization to feed the second-frequency-band radiator 4.

In this embodiment, the dual-frequency shared-aperture characteristic is achieved by embedding the second-frequency-band radiator 4 within the first-frequency-band radiator 2; the first-frequency-band radiator 2 and the second-frequency-band radiator 4 are both disposed at the feed base 1, and the feed base 1 simultaneously supports and electrically connects the first-frequency-band radiator 2 and the second-frequency-band radiator 4; the feed base 1 is also used to connect the external unit 200.

Each symmetrical dipole binary array of each polarization of the first-frequency-band radiator 2 includes two first-frequency-band dipoles 21, and the two first-frequency-band dipoles 21 are symmetrically disposed to form a polarization; the number of the first feed members 31 is the same as the number of the first-frequency-band dipoles 21, that is, the first-frequency-band feed group 3 includes at least two first feed members 31. An end of one first feed member 31 is electrically connected to one first-frequency-band dipole 21, and ends of two first feed members 31 corresponding to two first-frequency-band dipoles 21 of the same polarization that are not electrically connected to the first-frequency-band dipole 21 are combined, that is, one end of each first feed member 31 of the two first feed members 31 are combined, and then to be connected to the feed balun 12. The feed balun 12 plays the role of a combining connection end, and ports of two first-frequency-band dipoles 21 are combined into one port to access an external signal, to feed the external signal to radiation arms of the two first-frequency-band dipoles 21. As such, the input signal is fed to a polarization of the first-frequency-band radiator 2 through the feed balun 12 and the first feed member 31 via the external unit 200, achieving signal input to the first-frequency-band radiator 2.

The second feed member 51 includes a connecting section and a feed section. The connecting section may penetrate through the feed base 1 and the first-frequency-band radiator 2 to connect the external unit 200 for accessing the external signal. The feed section is connected to a second-frequency-band binary array of a polarization of the second-frequency-band radiator 4, for feeding of the external signal to the second-frequency-band binary array of the polarization. As such, the input signal feeds a polarization of the second-frequency-band radiator 4 by the second feed member 51 via the external unit 200, achieving the signal input for the second-frequency-band radiator 4.

In the dual-frequency shared-aperture radiation unit of the present application, the first-frequency-band radiator 2 and the second-frequency-band radiator 4 are embedded and share feed base 1, which results in a compact structure of the dual-frequency shared-aperture radiation unit, achieves the miniaturization of the radiation unit and further reduces the windward area of the antenna; the signal is input to the first-frequency-band radiator 2 through the feed balun 12, and the signal is input to the second-frequency-band radiator 4 through the second-frequency-band feed group 5. On the basis of traditional radiation units, terminals and radiation unit lines are removed, which may reduce the number of holes on a reflector plate, improve intermodulation stability, reduce hidden danger in intermodulation caused by welding operations, improve reliability, and achieve low costs; the second-frequency-band radiator 4 is separated from the feed base 1, and the second-frequency-band radiator 4 does not require electroplating, which may save electroplating costs and further reduce costs. Then, on the basis of antenna miniaturization, the fusion of multiple frequency bands and multiple standards may be achieved, and the indicators of each frequency band do not deteriorate, solving the shortcomings of low reliability and high costs of multi-frequency and multi-system antennas in the related art.

In an embodiment, the first-frequency-band radiator 2 is a low-frequency radiator, and the second-frequency-band radiator 4 is a high-frequency radiator. A frequency of the low-frequency radiator is lower than a frequency of the high-frequency radiator, that is, a radiation frequency of the first-frequency-band radiator 2 is lower than a radiation frequency of the second-frequency-band radiator 4.

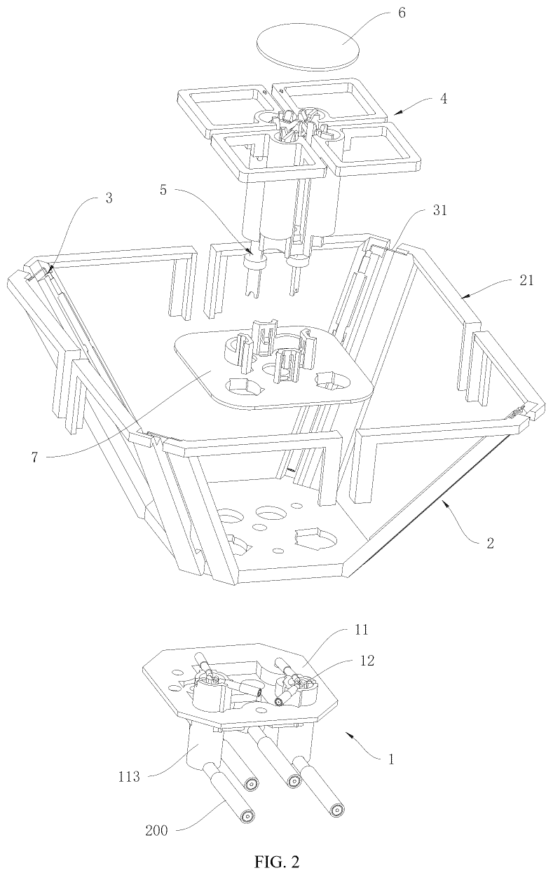

In an embodiment, as shown in FIG. 2, the first-frequency-band radiator 2, the second-frequency-band radiator 4, and the feed base 1 are separately disposed. By adopting a separate structure for the first-frequency-band radiator 2, the second-frequency-band radiator 4, and the feed base 1, both the first-frequency-band radiator 2 and the second-frequency-band radiator 4 do not require electroplating, reducing costs and making production more environmentally friendly.

In an embodiment, the first-frequency-band radiator 2, the second-frequency-band radiator 4, and the feed base 1 are connected to each other to avoid contact and improve intermodulation stability.

In another embodiment, the first-frequency-band radiator 2 is rigidly connected to the second-frequency-band radiator 4 and the feed base 1 through a metal fastener. For example, the metal fastener is a metal screw. Adopting a rigid connection ensures greater stability and reliability.

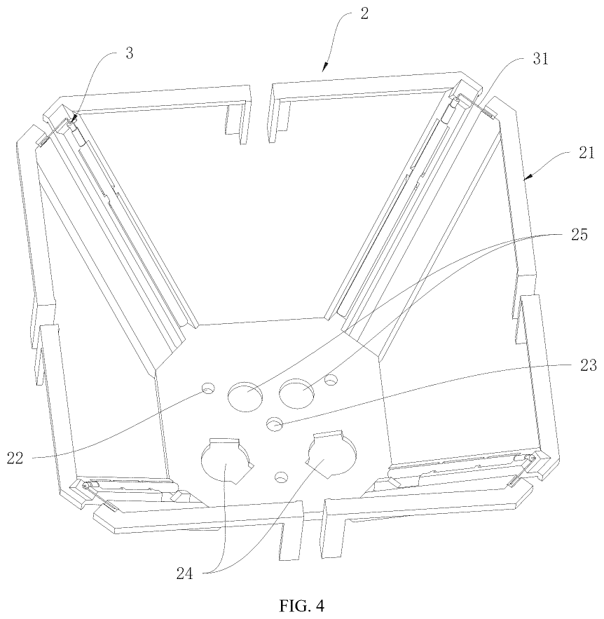

In an embodiment, as shown in FIG. 4, a bottom of the first-frequency-band radiator 2 is provided with a first connecting hole 22 and a second connecting hole 23. The first connecting hole 22 is fixedly connected to the metal base 11 through a fastener, and the second connecting hole 23 is fixedly connected to the second-frequency-band radiator 4 through a fastener, to rigidly connect the first-frequency-band radiator 2, the second-frequency-band radiator 4, and the feed base 1. The dual-frequency shared-aperture radiation unit may also be fixedly connected to a reflector plate of the antenna through a fastener, such as a screw.

In an embodiment, the first connecting hole 22 and the second connecting hole 23 are metal holes; the number of the first connecting hole 22 may be multiple, such as three, and the three first connecting holes 22 are not collinear, making the connection between the first-frequency-band radiator 2 and the metal base 11 more secure, stable, and reliable.

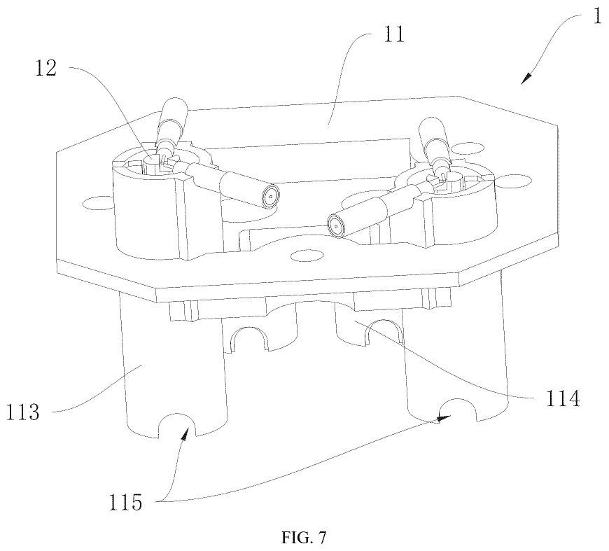

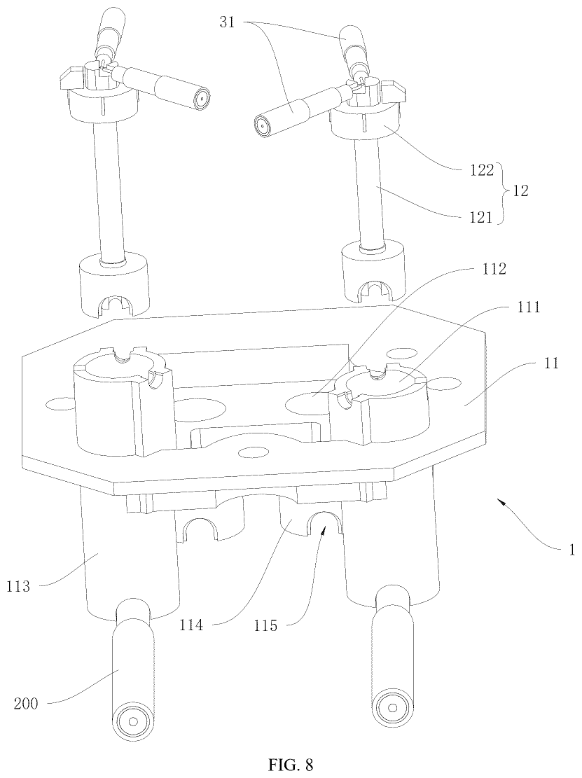

In an embodiment, as shown in FIG. 7 and FIG. 8, the metal base 11 is provided with a first through-hole 111; the feed balun 12 includes an inner core 121 and a plastic medium 122. The plastic medium 122 is wrapped around an outside of the inner core 121, and the inner core 121 and the plastic medium 122 are embedded in the first through-hole 111; a first end of the inner core 121 is connected to the first feed member 31, and a second end of the inner core 121 is connected to the external unit 200.

In this embodiment, the feed balun 12 is embedded in the metal base 11 by providing the first through-hole 111, with the inner core 121 and the plastic medium 122 embedded in the first through-hole 111. By providing the plastic medium 122, the inner core 121 may be protected, and the inner core 121 may be isolated from the inner wall of the first through-hole 111 to prevent short circuits caused by contact between the inner core 121 and the metal base 11. At the same time, it may also avoid short circuits caused by the inner core 121 shaking left and right and contacting an external conductor of the feed balun 12, and the connection is more stable, improving the stability of indicators of the radiation unit. A first end of the inner core 121 is located on a side of the metal base 11 near the first-frequency-band radiator 2, and is connected to two first feed members 31 of the same polarization for combination; a second end of the inner core 121 is located on a side of the metal base 11 away from the first-frequency-band radiator 2, to be connected to the external unit 200, and to achieve the feeding to one of the polarizations of the first-frequency-band radiator 2 by the input signal through the first-frequency-band feed group 3 and via the external unit 200.

In an embodiment, as shown in FIG. 1 to FIG. 4, the first-frequency-band radiator 2 consists of two symmetrical dipole binary arrays forming two polarizations, and the two polarizations are disposed orthogonally, for example, the two polarizations are disposed at ±45°. One dipole binary array forms one polarization, and another dipole binary array forms another polarization. That is, the first-frequency-band radiator 2 includes four first-frequency-band dipoles 21; correspondingly, the first-frequency-band feed group 3 includes four first feed members 31, and the four first feed members 31 are disposed in one-to-one correspondence with the four first-frequency-band dipoles 21 to achieve signal input for the two polarizations of the first-frequency-band radiator 2.

In an embodiment, the first-frequency-band dipole 21 is a half-wave bowl-shaped radiation oscillator, and the first-frequency-band radiator 2 is provided with two binary arrays consisting of two half-wave bowl-shaped radiation oscillators at ±45°, thus enclosing an installation space inside the first-frequency-band radiator 2; the second-frequency-band radiator 4 is embedded and installed in the installation space of the first-frequency-band radiator 2.

In an embodiment, the first feed member 31 is a coaxial cable, an inner conductor of the coaxial cable is connected to the feed balun 12, and an outer conductor of the coaxial cable is connected to the metal base 11.

In this embodiment, the first-frequency-band feed group 3 is connected through the coaxial cable, for example, the coaxial cable may be a coaxial wire. A first end of the inner conductor of the coaxial cable is connected to the first-frequency-band radiator 2, and a second end is connected to the inner core 121 of the feed balun 12 embedded in the metal base 11, achieving signal input to the first-frequency-band radiator 2. Coaxial cable has a simple structure, low costs, stable feed effect, and high reliability.

In an embodiment, the first-frequency-band feed group 3 is composed of four coaxial cables. An end of each of the four coaxial cables is connected in one-to-one correspondence with the four first-frequency-band dipoles 21 in the two symmetrical dipole binary arrays. Another end of each of the two coaxial cables of the same polarization not connected to the first-frequency-band dipole 21 is connected to the feed base 1 after being combined. Another end of each of the two coaxial cables of the another polarization not connected to the first-frequency-band dipole 21 is connected to the feed base 1 after being combined.

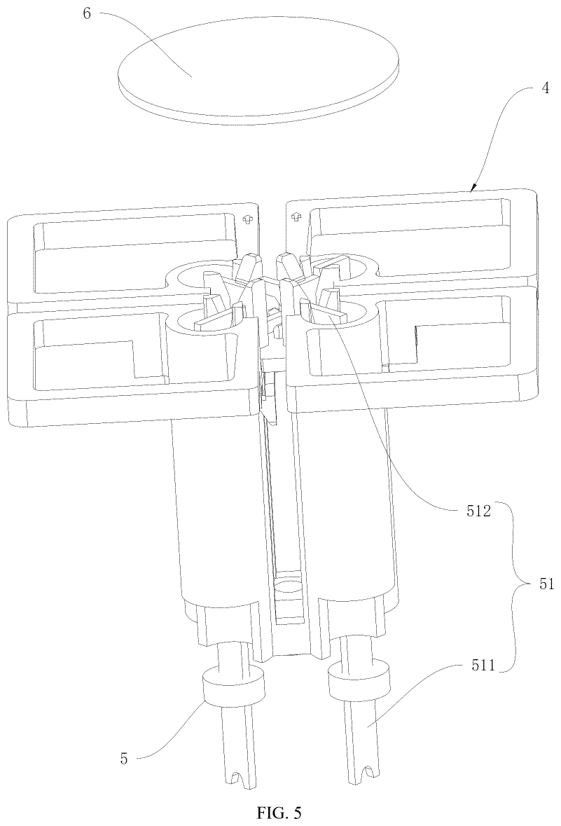

In an embodiment, as shown in FIG. 5 to FIG. 9, the metal base 11 is further provided with a second through-hole 112; the second feed member 51 includes a connecting section 511 and a feed section 512. The connecting section 511 is passed through the second through-hole 112 to connect to the external unit 200, and the feed section 512 is connected to a corresponding second-frequency-band binary array.

In this embodiment, the connecting section 511 of the second feed member 51 is a connecting part, and the feed section 512 is a feed part. By providing the second through-hole 112, the connecting section 511 is passed through the second through-hole 112 of the metal base 11, and then the connecting section 511 may be connected to the external unit 200 after being passed through the metal base 11; the feed section 512 is disposed correspondingly to a second-frequency-band binary array of a polarization of the second-frequency-band radiator 4, which enables that the second-frequency-band radiator 4 is fed by the input signal through the second-frequency-band feed group 5 and via the external unit 200.

In an embodiment, the second-frequency-band radiator 4 consists of two symmetrical dipole binary arrays forming two polarizations, and the two polarizations are disposed orthogonally, for example, the two polarizations are disposed at ±45°; correspondingly, the second-frequency-band feed group 5 includes feed structures corresponding to two polarizations, that is, the second-frequency-band feed group 5 includes two second feed members 51, and the two second feed members 51 are disposed in one-to-one correspondence with the two polarizations of the second-frequency-band radiator 4, to achieve signal input for the two polarizations of the second-frequency-band radiator 4. The connecting section 511 of the second feed member 51 is a feed matching part, and the feed section 512 has an open-circuit stub.

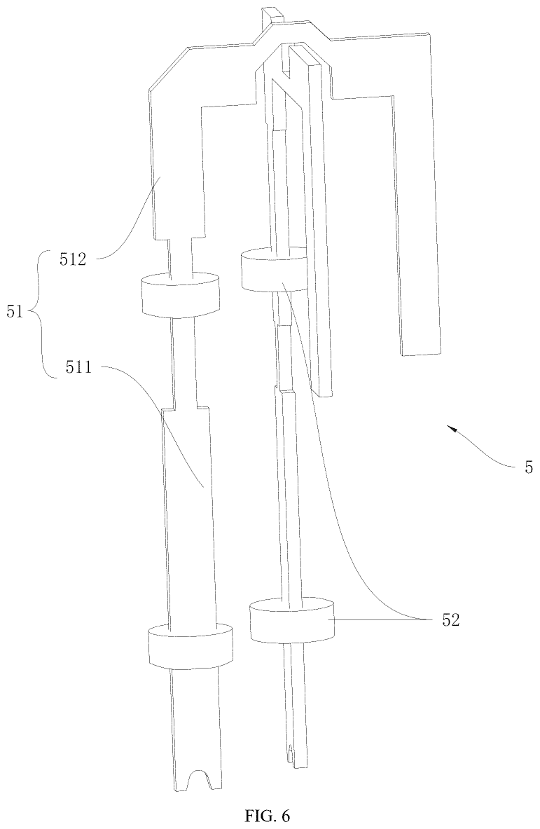

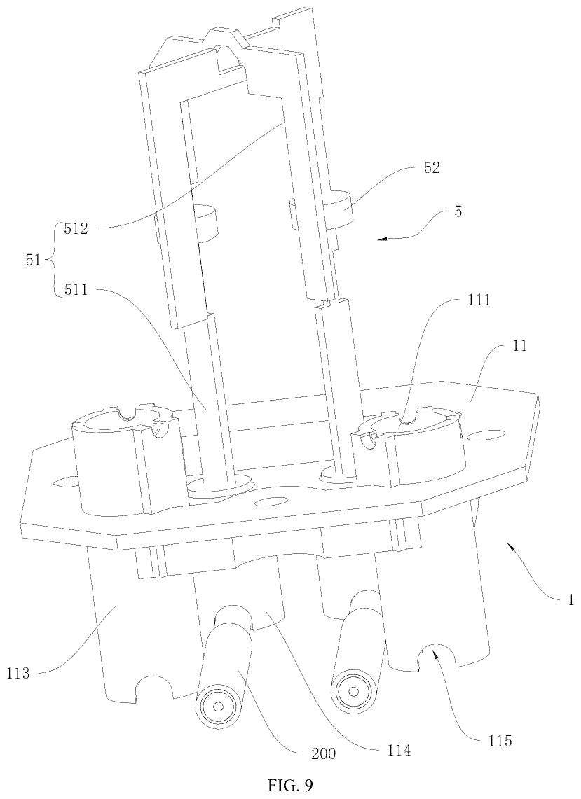

In an embodiment, as shown in FIG. 6 and FIG. 9, the second-frequency-band feed group 5 also includes an isolating member 52, for example, the isolating member 52 may be plastic. The isolating member 52 is wrapped around an outer part of the connecting section 511 of the second feed member 51. When the connecting section 511 is passed into the second through-hole 112, the isolating member 52 is located between the connecting section 511 and an inner wall of the second through-hole 112, avoiding contact between the second feed member 51 and the metal base 11, protecting the second feed member 51, and avoiding contact between the second feed member 51 and the second-frequency-band radiator 4, ensuring feed effect and improving intermodulation stability.

In an embodiment, the second feed member 51 is one of a sheet metal member, a die-casting member, or a printed circuit member. By using sheet metal member, die-casting member, or printed circuit member to manufacture the second feed member 51, the structure is simple, easy to form, and the costs are relatively low.

In an embodiment, the second-frequency-band radiator 4 and/or the second feed member 51 adopt an integrally formed structure, which is simple in structure, has good consistency, longer in service life, and lower in costs.

In an embodiment, as shown in FIG. 1, FIG. 2, and FIG. 5, the dual-frequency shared-aperture radiation unit further includes a director with sheet-like structure 6, the director with sheet-like structure 6 is disposed at a side of the second-frequency-band radiator 4 facing away from the feed base 1, and the director with sheet-like structure 6 and the second-frequency-band radiator 4 are disposed at intervals.

In this embodiment, by providing the director with sheet-like structure 6, the director with sheet-like structure 6 being located above the second-frequency-band radiator 4, the antenna beamforming effect may be achieved, improving the indicators such as horizontal beam width and gain, enhancing the radiation performance of the second-frequency-band radiator 4, and improving reliability.

In an embodiment, as shown in FIG. 1 to FIG. 3 and FIG. 7 to FIG. 9, a bottom of the metal base 11 is provided with a first metal support 113 and a second metal support 114, the first through-hole 111 penetrates through the first metal support 113, and the second through-hole 112 penetrates through the second metal support 114; the bottom of the first-frequency-band radiator 2 is provided with a first metal via-hole 24 and a second metal via-hole 25, the first metal via-hole 24 is disposed corresponding to the first through-hole 111, and the second metal via-hole 25 is disposed corresponding to the second through-hole 112.

In this embodiment, the metal base 11 is connected to the outer conductor of the external unit 200 through the first metal support 113 and the second metal support 114 disposed at the bottom; the feed balun 12 is embedded in the first metal support 113 through the first through-hole 111, and the plastic medium 122 of the feed balun 12 is fixedly connected to the first metal support 113. The second end of the inner core 121 of the feed balun 12 is electrically connected to the inner conductor of the external unit 200; the first-frequency-band radiator 2 is connected to the metal base 11, and the first metal via-hole 24 is disposed corresponding to the first through-hole 111. The first end of the inner core 121 of the feed balun 12 passes through the first metal via-hole 24 and is connected to two first feed members 31 of the same polarization for combination; the second metal via-hole 25 is disposed corresponding to the second through-hole 112, and the connecting section 511 of the second feed member 51 passes through the second metal via-hole 25 and the second through-hole 112 to electrically connect to the inner conductor of the external unit 200. The feed base 1 may support and electrically connect the first-frequency-band radiator 2 and the second-frequency-band radiator 4, as well as connect the first feed member 31 and the second feed member 51 to the external unit 200 for inputting the external signal. Its compact structure is conducive to antenna miniaturization.

In an embodiment, the first metal support 113 and the second metal support 114 are metal columns, and a welding notch 115 is disposed at a bottom of the metal column to facilitate welding between the metal column and the outer conductor of the external unit 200.

In an embodiment, the external unit 200 may be a radio frequency transmission unit, such as a coaxial cable, where the metal column is welded to the outer conductor of the coaxial cable, and the dual-frequency shared-aperture radiation unit accesses the external signal through the coaxial cable.

In an embodiment, both the first-frequency-band radiator 2 and the second-frequency-band radiator 4 include two polarizations, the first-frequency-band feed group 3 includes four first feed members 31, and the second-frequency-band feed group 5 includes two second feed members 51; correspondingly, the feed base 1 includes two feed baluns 12, and the bottom of the metal base 11 is provided with four metal columns, two of the metal columns are the first metal supports 113, used to connect to the first-frequency-band feed group 3, and the other two metal columns are the second metal supports 114, used to connect to the second-frequency-band feed group 5.

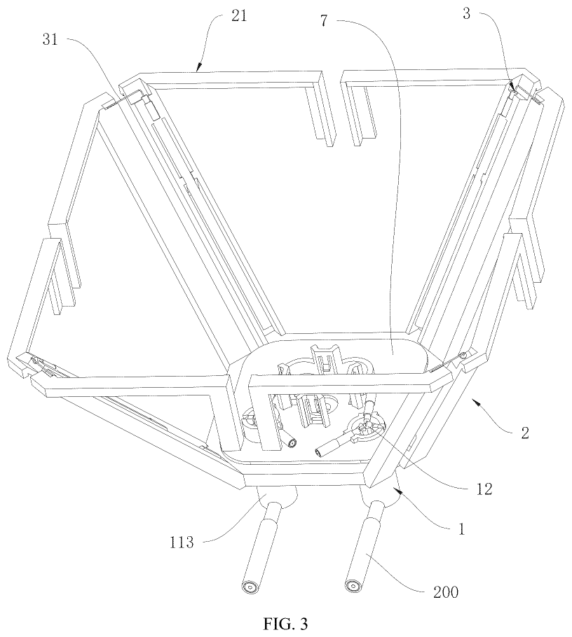

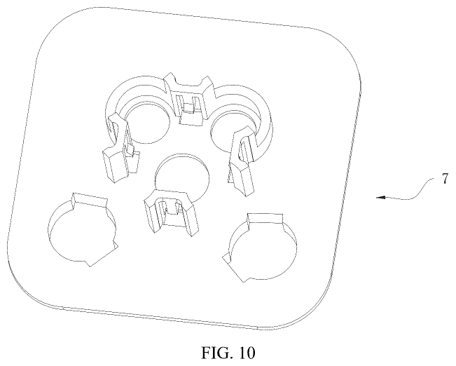

In an embodiment, as shown in FIG. 2, FIG. 3, and FIG. 10, the dual-frequency shared-aperture radiation unit further includes a plastic member 7, and the plastic member 7 is disposed between the first-frequency-band radiator 2 and the second-frequency-band radiator 4. The first metal via-hole 24 and the second metal via-hole 25 are connected to the metal base 11 through the plastic member 7. The feed base 1, the first-frequency-band radiator 2, and the second-frequency-band radiator 4 are fixed to each other by the plastic member 7. The plastic member 7 fixes the second-frequency-band radiator 4 to provide insulation, which may reduce the contact between the first-frequency-band radiator 2 and the second-frequency-band radiator 4 and improve intermodulation stability.

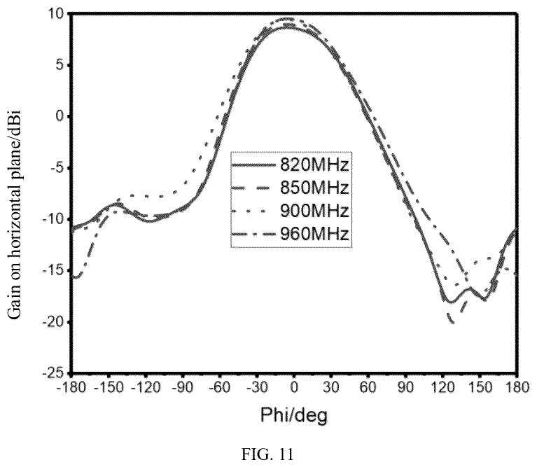

FIG. 11 is a radiation parameter diagram of a first-frequency-band radiation of a dual-frequency shared-aperture radiation unit on a horizontal plane according to an embodiment of the present application. In FIG. 11, a horizontal axis represents an angle Phi with a unit of degree (deg), and the angle is an azimuth angle on a horizontal plane; a vertical axis represents a gain on the horizontal plane with a unit of dBi. Each curve is a variation curve of gain on the horizontal plane with azimuth angle Phi at different frequencies when the phase angle Theta is 90°, that is, the horizontal plane directional diagram at different frequencies. It may be seen that the horizontal plane directional diagram of the first-frequency-band radiation of the dual-frequency shared-aperture radiation unit of the present application basically overlaps at various frequencies, with small differences.

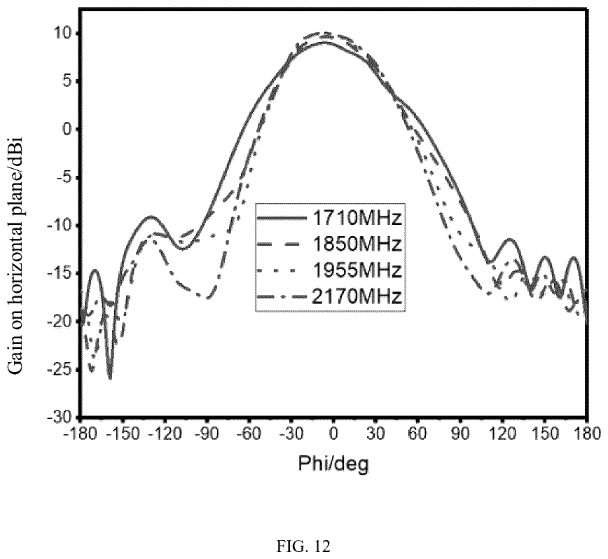

FIG. 12 is a radiation parameter diagram of a second-frequency-band radiation of a dual-frequency shared-aperture radiation unit on a horizontal plane according to an embodiment of the present application. In FIG. 12, a horizontal axis represents an angle Phi with a unit of degree (deg), and the angle is an azimuth angle on a horizontal plane; a vertical axis represents a gain on the horizontal plane with a unit of dBi. Each curve is a variation curve of gain on the horizontal plane with azimuth angle Phi at different frequencies when the phase angle Theta is 90°, that is, the horizontal plane directional diagram at different frequencies. It may be seen that the horizontal plane directional diagram of the second-frequency-band radiation of the dual-frequency shared-aperture radiation unit of the present application has a small difference at each frequency.

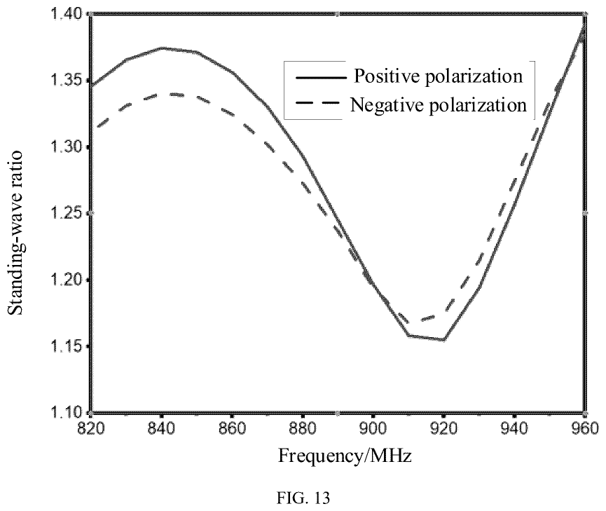

FIG. 13 is a standing-wave ratio curve of a first-frequency-band radiation of a dual-frequency shared-aperture radiation unit according to an embodiment of the present application. In FIG. 13, a horizontal axis represents frequency with a unit of MHz; a vertical axis is a standing-wave ratio. A solid line represents a standing-wave ratio to frequency curve of positive polarization (+45° polarization) in the first-frequency-band, and a dashed line represents a standing-wave ratio to frequency curve of negative polarization (−45° polarization) in the first-frequency-band. It may be seen that the dual-frequency shared-aperture radiation unit of the present application has a standing-wave ratio of less than 1.4 in a low-frequency range.

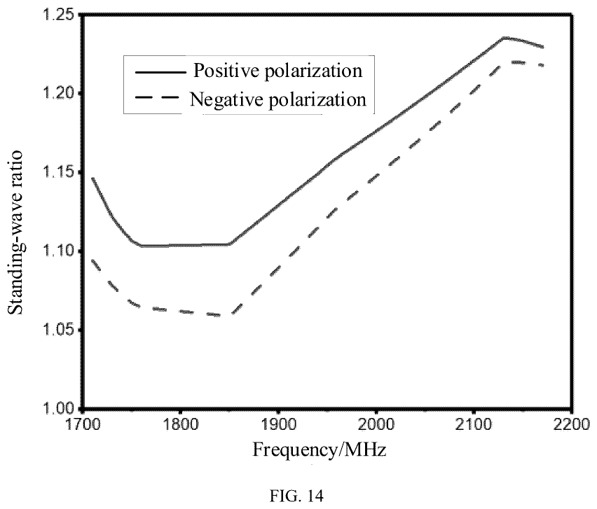

FIG. 14 is a standing-wave ratio curve of a second-frequency-band radiation of a dual-frequency shared-aperture radiation unit according to an embodiment of the present application. In FIG. 14, a horizontal axis represents frequency with a unit of MHz; a vertical axis is a standing-wave ratio. A solid line represents a standing-wave ratio to frequency curve of positive polarization (+45° polarization) in the second-frequency-band, and a dashed line represents a standing-wave ratio to frequency curve of negative polarization (−45° polarization) in the second-frequency-band. It may be seen that the dual-frequency shared-aperture radiation unit of the present application has a standing-wave ratio of less than 1.25 in a high-frequency range.

The dual-frequency shared-aperture radiation unit of the present application has a low standing-wave ratio in both the low-frequency range and high-frequency range, good impedance matching, and good intermodulation stability, ensuring that the indicators of each frequency band do not deteriorate, with high reliability and low costs. In an embodiment, the present application further provides an antenna, including a dual-frequency shared-aperture radiation unit provided by any of the above embodiments.

In an embodiment, the antenna includes multiple dual-frequency shared-aperture radiation units, and the multiple dual-frequency shared-aperture radiation units are a combination of same frequency units or at least partially different frequency units.

In this embodiment, the dual-frequency shared-aperture radiation unit may obtain a multi-frequency-band fusion base station antenna through appropriate layout, improving intermodulation stability with low costs, which solves the shortcomings of low reliability and high costs of multi-frequency and multi-system antennas in the related art.

The antenna may adopt a combination of same frequency units, that is, multiple dual-frequency shared-aperture radiation units have the same operating frequency band, and the antenna may simultaneously receive/transmit signals from multiple devices in the same frequency band.

The antenna may also adopt a combination of at least partially different frequency units, where at least one of the multiple dual-frequency shared-aperture radiation units is of different operating frequency band than others, allowing the antenna to simultaneously receive/transmit signals from multiple devices in more frequency bands.

The antenna in the embodiments of the present application is more convenient and flexible to use, meeting various usage requirements.

1. A dual-frequency shared-aperture radiation unit, comprising:
a feed base, comprising a metal base and a feed balun, wherein the feed balun is embedded in the metal base and the feed balun is connected to an external unit;
a first-frequency-band radiator, disposed at the metal base, wherein the first-frequency-band radiator comprises at least one polarization composed of a symmetrical dipole binary array;
a first-frequency-band feed group, comprising multiple first feed members, wherein an end of one first feed member is connected to one first-frequency-band dipole, and ends of two first feed members of the same polarization not connected to the first-frequency-band dipole are combined to the feed balun to feed the first-frequency-band radiator;
a second-frequency-band radiator, embedded in the first-frequency-band radiator and disposed at the metal base, wherein the second-frequency-band radiator comprises at least one polarization composed of a symmetrical dipole binary array; and
a second-frequency-band feed group, comprising at least one second feed member, wherein one second feed member is disposed corresponding to a second-frequency-band binary array of one polarization to feed the second-frequency-band radiator.

2. The dual-frequency shared-aperture radiation unit of claim 1, wherein the metal base is provided with a first through-hole; the feed balun comprises an inner core and a plastic medium, wherein the plastic medium is wrapped around an outside of the inner core, and the inner core and the plastic medium are embedded in the first through-hole; a first end of the inner core is connected to the first feed member, and a second end of the inner core is connected to the external unit.

3. The dual-frequency shared-aperture radiation unit of claim 2, wherein the metal base is further provided with a second through-hole; the second feed member comprises a connecting section and a feed section, wherein the connecting section is passed through the second through-hole and connected to the external unit, and the feed section is connected to a corresponding second-frequency-band binary array.

4. The dual-frequency shared-aperture radiation unit of claim 3, wherein a bottom of the metal base is provided with a first metal support and a second metal support, the first through-hole penetrates through the first metal support, and the second through-hole penetrates through the second metal support; a bottom of the first-frequency-band radiator is provided with a first metal via-hole and a second metal via-hole, wherein the first metal via-hole is disposed corresponding to the first through-hole, and the second metal via-hole is disposed corresponding to the second through-hole.

5. The dual-frequency shared-aperture radiation unit of claim 1, wherein the first-frequency-band radiator, the second-frequency-band radiator, and the feed base are separately disposed.

6. The dual-frequency shared-aperture radiation unit of claim 5, wherein the first-frequency-band radiator is connected to the second-frequency-band radiator and the feed base, or the first-frequency-band radiator is rigidly connected to the second-frequency-band radiator and the feed base through a metal fastener.

7. The dual-frequency shared-aperture radiation unit of claim 5, wherein a bottom of the first-frequency-band radiator is provided with a first connecting hole and a second connecting hole, wherein the first connecting hole is fixedly connected to the metal base through a fastener, and the second connecting hole is fixedly connected to the second-frequency-band radiator through a fastener.

8. The dual-frequency shared-aperture radiation unit of claim 1, wherein the first feed member is a coaxial cable, wherein an inner conductor of the coaxial cable is connected to the feed balun, and an outer conductor of the coaxial cable is connected to the metal base.

9. The dual-frequency shared-aperture radiation unit of claim 1, wherein the second feed member is one of a sheet metal member, a die-casting member, or a printed circuit member.

10. The dual-frequency shared-aperture radiation unit of claim 1, further comprising a director with sheet-like structure, wherein the director with sheet-like structure is disposed at a side of the second-frequency-band radiator facing away from the feed base, and the director with sheet-like structure and the second-frequency-band radiator are disposed at intervals.

11. An antenna, comprising the dual-frequency shared-aperture radiation unit of claim 1.

12. The antenna of claim 11, wherein the antenna comprises multiple dual-frequency shared-aperture radiation units, and the multiple dual-frequency shared-aperture radiation units are a combination of same frequency units or at least partially different frequency units.
